(19) United States
(12) Patent Application Publication
(10) Pub. No.: US 2012/0212805 A1
(43) Pub. Date: Aug. 23, 2012

(54) Lens Unit for Infrared Camera and Infrared Camera Using the Same

(75) Inventors: Atsushi Koide, Saitama-shi (JP); Fumiyoshi Nishimura, Saitama-shi (JP)

(73) Assignee: TAMRON CO., LTD., Saitama-shi (JP)

(21) Appl. No.: 13/400,946

(22) Filed: Feb. 21, 2012

(30) Foreign Application Priority Data
Feb. 22, 2011 (JP) 2011-036359
Feb. 22, 2011 (JP) 2011-036360

(51) Int. Cl. G02B 13/14

(52) U.S. Cl. 359/356

(57) ABSTRACT

A lens unit for an infrared camera is provided with one or more infrared transmitting lenses; a lens barrel which houses the infrared transmitting lens via a lens holding frame; and an actuator for performing image fluctuation correction of an infrared transmitting lens serving as a correction lens using magnetic means to prevent image fluctuation of a photographed image. The lens holding frame for the infrared transmitting lens serve as the correction lens and includes a fixing opening for the infrared transmitting lens and a shielding wall standing in an optical axis direction on an outer periphery of the fixing opening for the lens, and a separating space is provided between the correction lens and the lens barrel.

### BACKGROUND OF THE INVENTION

1. Field of the Invention

The present invention relates to a lens unit for infrared camera, and more specifically to a lens unit provided with a mechanism that prevents fluctuation of a photographed image and an infrared camera using the same.

2. Description of the Related Art

Conventionally, there has been an infrared camera provided with a mechanism that prevents fluctuation of a photographed image (image fluctuation) caused by a hand movement of a photographer or the like in a lens barrel. When hand movement occurs in an infrared camera during shooting, no matter how correct focusing and suitable adjustment of exposure are executed, a luminous flux from the object-side is shifted against to an optical axis of a lens, whereby definition of an object image is deteriorated. Accordingly, in infrared cameras, as the technology to correct fluctuation of a photographed image, “an optical correction method to correct image fluctuation by moving a shift lens or an image sensor in the direction to cancel the detected amount of fluctuation” and “an electronic correction method to correct image fluctuation by image processing based on comparison between a photographed image and images photographed thereafter.” are mainly applied

However, an image sensor of an infrared camera (especially, for a mid-infrared region and a far-infrared region) has the smaller number of pixels, and high-precision correction cannot be performed in electronic type correction. Then, in current infrared cameras, such a method that a correction lens having a sensor called as a vibrating gyroscope in a lens barrel is mounted, and the correction lens is driven in the direction to cancel image fluctuation in accordance with the amount of shift of an imaging lens to maintain a luminous flux which reaches to an imaging surface in a constant state (a lens shift method) among optical correction methods is mainly adopted.

In such a kind of infrared cameras provided with a mechanism that controls a position of a correction lens to optically correct fluctuation of a photographed image, a sensor in a lens barrel detects angular velocity components of an imaging lens due to hand movement or the like, and a signal detected by the sensor is subjected to arithmetic processing by a microcomputer, whereby a signal for driving the correction lens is transmitted to an actuator for driving the correction lens. Note that in the correction lens, an effect of preventing fluctuation of a photographed image can be further improved by directly driving by using an actuator excellent in response and controllability.

As a mechanism that optically corrects such fluctuation of a photographed image, for example, a VC (vibration compensation) method disclosed in Japanese Patent Laid-Open No. 2006-174588 entitled “Actuator, and lens unit and camera with the same” previously filed by the present applicant can be mentioned (Patent Document 1). More specifically, the VC method disclosed in the Patent Document 1 is characterized in that an actuator comprises a fixed member; a movable member; a movable member supporting means for supporting the movable member relative to the fixed member; an actuating coil attached to either one of the fixed member and the movable member; an actuating magnet attached to the remaining one of the fixed member and the movable member in positions so as to receive drive force when current flows in the actuating coils; a magnetic sensor disposed inside windings of the actuating coil for detecting positions of the actuating magnet; and a control means for controlling the drive current to flow in each of the actuating coil in response to a signal instructing where to move the movable member and position signal detected by the magnetic sensor.

However, the mechanism to optically correct fluctuation of a photographed image disclosed in Patent Document 1 is mounted in a lens barrel to maintain high precision of image fluctuation correction. That is, when the mechanism is adopted in an infrared camera, image quality may be deteriorated due to radiation of infrared rays from an actuator for driving a correction lens. An infrared camera can photograph an image by detecting infrared rays radiated from a heat source such as a human being, and can accurately perform object recognition in the dark. With recent increased attention to security and increased awareness of safety in driving a car at night, demands for an infrared camera tends to increase year by year.

Accordingly, there has been a need for a lens unit for infrared camera which can obtain a clear image without reflecting heat emitted from an actuator on a photographed image even when such a mechanism is applied to prevent fluctuation of a photographed image.

Moreover, a motor for driving a zooming lens as an electrical or electronic device as a heat source is provided in a lens barrel of an infrared camera in addition to the actuator. Because the motor for driving zooming lens generates a large amount of heat in operation, even when a heat pipe is provided to the motor, temperature elevation cannot be fully inhibited and heat emitted from the motor reflects on a photographed image, i.e. image quality may be deteriorated.

The present invention has been made in view of such conventional problems, and it is an object of the present invention to provide a lens unit for infrared camera that prevents reflection, on a photographed image, of heat emitted from electrical or electronic devices such as an actuator constituting a mechanism that optically corrects fluctuation of a photographed image and a motor that drives a zooming lens.

### BRIEF DESCRIPTION OF THE DRAWINGS

FIG. 1 is a schematic cross-sectional view illustrating a lens unit for infrared camera concerning an embodiment according to the present invention;

FIG. 2 is a main part cross-sectional view of a section shown by a in FIG. 1;

FIG. 3 is a schematic cross-sectional view illustrating a lens unit for infrared camera concerning another embodiment according to the present invention; and

FIG. 4 is a schematic cross-sectional view illustrating a lens unit for infrared camera concerning still another embodiment according to the present invention.

### SUMMARY OF THE INVENTION

As a result of intensive studies, the present inventors have adopted the following lens unit for infrared camera for solving the above described problems.

A lens unit for infrared camera according to the present invention including: one or more infrared transmitting lenses; a lens barrel which houses the infrared transmitting lens via a lens holding frame; and an actuator performing image fluctuation correction of an infrared transmitting lens serving as a correction lens using magnetic means to prevent image fluctuation of a photographed image, wherein the lens holding frame for the infrared transmitting lens serving as the correction lens includes a fixing opening for the infrared transmitting lens and a shielding wall standing in the optical axis direction on an outer periphery of the fixing opening for the lens, and a separating space is provided between the correction lens and the lens barrel.

Further, in the lens unit for infrared camera according to the present invention, a heat radiation wall is preferably provided on at least one of the object side and the imaging side along the optical axis in the separating space.

Further, in the lens unit for infrared camera according to the present invention, the heat radiation wall is preferably disposed from a distal end of the shielding wall provided on the lens holding frame for the correction lens toward an inner wall of the lens barrel.

Further, in the lens unit for infrared camera according to the present invention, the heat radiation wall preferably extends from the inner wall of the lens barrel.

Further, in the lens unit for infrared camera according to the present invention, the shielding wall of the lens holding frame is preferably made of plastic resin.

Further, in the lens unit for infrared camera according to the present invention, the lens barrel preferably includes a heat sink on its outer peripheral surface.

Further, the lens unit for infrared camera according to the present invention preferably includes a motor that makes an infrared transmitting lens serving as a zooming lens travel along the optical axis, wherein the zooming lens is made capable of sliding along a lead screw and a guide pole by being driven by a motor.

Further, in the lens unit for infrared camera according to the present invention, the lens barrel preferably includes a motor housing recess on its outer peripheral surface.

Further, in the lens unit for infrared camera according to the present invention, the lens barrel preferably includes the motor housing recess for housing the motor on its outer peripheral surface to prevent that the motor substantially protrudes from the outer peripheral surface of the lens barrel and houses the motor therein, and is provided with a lid body that covers the lead screw and the guide pole from the outer peripheral side of the lens barrel and makes the lens barrel hermetically sealable.

Further, in the lens unit for infrared camera according to the present invention, the motor is preferably a stepping motor.

Further, in the lens unit for infrared camera according to the present invention, the lens barrel and the heat radiation wall are preferably made of a metal material having high thermal conductivity selected from an aluminum-base metal material and an iron-base metal material.

Further, the infrared camera according to the present invention is characterized in using the lens unit for infrared camera described above.

The lens unit for infrared camera according to the present invention can inhibit inconvenience of deterioration of image quality due to heat emitted from an actuator of a mechanism to optically correct fluctuation of a photographed image or heat emitted from a motor for moving a zooming lens. Accordingly, the lens unit for infrared camera according to the present invention and the infrared camera using the same can be preferably used as a night vision camera.

### DETAILED DESCRIPTION OF THE PREFERRED EMBODIMENTS

Now, an embodiment of the present invention will be described with reference to the accompanying drawings. Note that, in the drawings shown later, various hatchings which are used when a cross section of each member is shown are omitted considering visibility of the drawings.

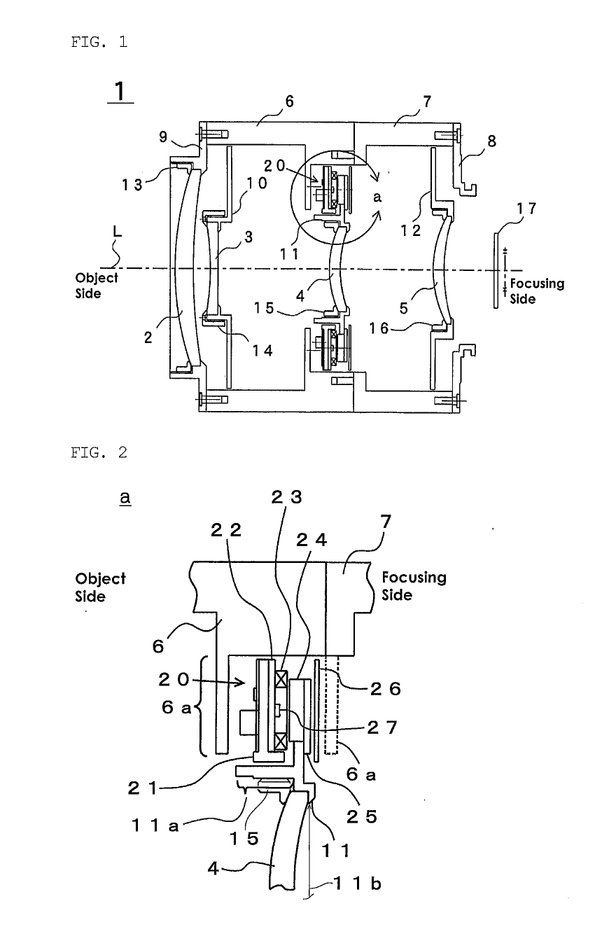

The lens unit for infrared camera according to the present invention: FIG. 1 is a schematic cross-sectional view illustrating a lens unit for infrared camera according to an embodiment of the present invention. Moreover, FIG. 2 is a main part cross-sectional view of a section shown by a in FIG. 1. As illustrated in FIGS. 1 and 2, a lens unit for infrared camera 1 according to the present invention includes a plurality of infrared transmitting lenses 2 to 5, lens barrels 6 and 7 which house the infrared transmitting lenses 2 to 5 via lens holding frames 9 to 12, and an actuator 20 for carrying out image fluctuation correction of an infrared transmitting lens serving as a correction lens using magnetic means to prevent fluctuation of a photographed image. Moreover, the lens holding frame 11 for the infrared transmitting lens 4 serving as the correction lens has a lens fixing opening 11b for the infrared transmitting lens 4 at the center and a shielding wall 11a standing in the direction of the optical axis L on an outer periphery of the lens fixing opening 11b. Further, the lens unit for infrared camera 1 according to the present invention is characterized in provided with a separating space between the correction lens 4 and the lens barrels 6 and 7 by placing the shielding wall 11a of the lens holding frame between the correction lens 4 fixed to the lens holding frame 11 and the actuator 20.

Here, FIGS. 1 and 2 illustrate a structure to make the correction lens 4 perform behavior of image fluctuation correction that a plurality of magnets 24 are arranged on an outer surface of the shielding wall 11a and the actuator 20 is provided adjacent to and substantially parallel with the magnets 24 of the lens holding frame for the correction lens. Depending on the structure of the lens unit for infrared camera 1 according to the present invention, heat generated by behavior of image fluctuation correction on the correction lens 4 is prevented from transmitting toward the inside of the lens barrel and heat discharge efficiency from the inner wall of the lens barrels 6 and 7 to the outside is improved, i.e. temperature elevation in the lens barrels 6 and 7 can be inhibited.

That is, in the lens unit for infrared camera 1 according to the present invention achieves improvement of image quality of a night vision image that reflects heat of an object to be recognized itself as a vision, by providing a separating space between the correction lens 4 and the lens barrels 6 and 7 to inhibit temperature elevation in the lens barrels 6 and 7. Note that, in an infrared camera (not shown), the higher the product quality is, the more heat generated in the lens barrel tends to be reflected, which adversely affects the quality of imaging. So, in the lens unit for infrared camera 1 according to the present invention, such structure is adopted that the actuator 20 is separated by being surrounded by walls to prevent reflection of heat emitted from the actuator 20 as a heat source on a photographed image as described above.

Note that, in the lens unit 1 according to the present invention illustrated in FIG. 1, the infrared transmitting lenses 2 to 5 are respectively fixed by lens pressing rings 13 to 16 of the lens holding frames 9 to 12. Additionally, the lens unit 1 according to the present invention can be electrically connected to a camera body (not shown) in an attachable and detachable manner by a mount 8 formed with a bayonet hook, for example. Further, by electrically connecting the infrared camera main body and the lens unit 1 by the mount 8, interactive signal transmission can be performed between the infrared camera main body side and the lens unit side.

First, a mechanism to optically correct image fluctuation in an embodiment of the present invention will be roughly described. As illustrated in FIG. 2, this mechanism includes the correction lens 4 to optically correct image fluctuation caused by hand movement or the like and the lens holding frame 11 which holds the correction lens 4. When the lens holding frame 11 is driven by the actuator 20, the correction lens 4 is moved and then an imaging position of an object image on an image sensor 17 can be corrected. In the state, the lens holding frame 11 can perform relative positional movement to a base member 21 smoothly because a clearance between the lens holding frame 11 and the base member 21 of this mechanism is constantly maintained by a ball (not shown) and rolling of the ball is utilized.

Moreover, the base member 21 regulates movement of the lens holding frame 11 and a circuit board 22 is fixed on its surface. On the circuit board 22, a coil 23 to which electrical power is supplied by a power supply (not shown) is fixed at a position facing a permanent magnet 24, and a Hall device 27 is mounted inside a wound coil 23. Then, a magnetic field is formed by the existence of a back yoke 25 that directs magnetism of the permanent magnet 24 to the coil 23. Moreover, this Hall device 27 detects change of magnetic flux density of the permanent magnet 24 caused by movement of the lens holding frame 11 to measure the position of the correction lens 4. Next, by control means included in this mechanism, arithmetic processing based on a position signal detected by the Hall device 27 is performed, and a signal to drive the correction lens 4 is transmitted to the actuator 20 to perform correction driving of the correction lens 4. Note that the driving of the correction lens 4 is performed utilizing Lorentz force act on an electron flow in the coil 23 when a current flows in the coil 23.

As described above, main object of the lens unit for infrared camera 1 according to the present invention is to prevent reflection of heat emitted from the actuator 20 as a heat source that performs behavior of image fluctuation correction on a photographed image. Accordingly, here, an infrared camera will be roughly described also. An infrared camera is a camera which can perform imaging (image display) by sensing infrared rays generated (radiated) from a human being or an animal in the dark. Here, infrared rays are mainly classified into near-infrared rays, mid-infrared rays and far-infrared rays depending on its wavelength range. Additionally, the infrared camera according to the present invention can detect infrared rays of a mid-infrared region and a far-infrared region. By using such infrared cameras, a human being or an animal existing in front of a camera can be rapidly and accurately recognized even in the dark. Infrared cameras are effective in a state that such method cannot be used that an optical source such as a light illuminates a front area in order to recognize a front object by visible reflected light, and preferably used as a complementation for recognizing far and side objects that a light source cannot reach in the dark.

As described above, when an infrared camera is used, it can be understood that a measure not to detect infrared rays radiated from a heat source is required in a case where a member which can be the heat source is arranged in a lens barrel. Note that, in such a case, means in which dedicated equipment to cool a heat source such as a heat pipe additionally used are not preferable because such means may make a structure complicated or the manufacturing cost increase. However, depending on the lens unit for infrared camera 1 according to the present invention, an effect of preventing reflection of a heat source on a photographed image can be obtained by providing the shielding wall 11a standing on the lens holding frame 11. Note that, FIGS. 1 and 2 illustrate that the shielding wall 11a stands toward the object side; however, the present invention is not limited to this configuration. For example, in the configuration illustrated in FIGS. 1 and 2, the shielding wall 11a can be provided to stand further toward the imaging side.

In addition, in the lens unit for infrared camera 1 according to the present invention, heat radiation walls 6a and 26 are preferably provided on at least one of the object side and the imaging side along the optical axis L in a separating space provided between the correction lens 4 and the lens barrels 6 and 7.

In the lens unit for infrared camera 1 according to the present invention, transmission of heat generated in a heat source to a center portion of the lens barrel is prevented more effectively to the actuator 20 by forming a separating space more similar to a complete closed space on at least one of the object side and the imaging side along the optical axis L using the heat radiation walls 6a (object side), 26 (imaging side). Additionally, FIG. 1 illustrates that the heat radiation wall 6a is provided only on the object side; however, the present invention is not limited to this configuration. For example, the heat radiation wall 6a can be further provided on the imaging side as shown by a dashed line in FIG. 2.

Note that, if the separating space formed in the lens barrels 6 and 7 of the present invention is a region similar to a closed space, temperature rapidly elevates in the space. So, it is necessary to further improve heat discharge efficiency from the inner wall of the lens barrel to the outside to inhibit temperature elevation in the lens barrel more effectively in such a case. Accordingly, it is more preferable that a wall provided to isolate the actuator 20 is composed of a material or a shape having a heat discharge function. As a result, the lens unit for infrared camera 1 according to the present invention can obtain a high quality night vision image without fluctuation due to sundry heat.

Also, in the lens unit for infrared camera 1 according to the present invention, the heat radiation walls 6a and 26 are preferably provided between the shielding wall 11a included in the lens holding frame 11 for the correction lens 4 and the inner wall of the lens barrel.

In such a case, the heat radiation wall 6a may be integrally formed from a distal end of the shielding wall 11a extending on the object side toward the inner wall of the barrel. In this case, the lens unit for infrared camera 1 according to the present invention can be easily achieved without special structure modification of the lens barrel by replacing a lens holding frame for a correction lens of an existing lens unit for infrared camera with the lens holding frame 11 according to the present invention.

Moreover, in addition to the configuration illustrated in FIGS. 1 and 2, the shielding wall 11a included in the lens holding frame 11 according to the present invention can be provided to stand further toward the imaging side. Although it is not illustrated, in such a case, a heat radiation wall provided from the distal end of the shielding wall 11a extending on the imaging side toward the inner wall of the lens barrel is shown by symbol 26. Note that, in the lens unit for infrared camera 1 according to the present invention, the heat radiation walls 6a and 26 may not contact to the inner wall of the lens barrels 6 and 7. In this case, even if the heat radiation wall 6a does not contact to the inner wall of the lens barrels 6 and 7, heat generated from a heat source can be discharged to the outside of the lens barrels 6 and 7 as long as both members are provided with a clearance capable of heat transmission.

Moreover, in the lens unit for infrared camera 1 according to the present invention, the heat radiation walls 6a and 26 may extend from the inner wall of the lens barrels 6 and 7. That is, in the lens unit for infrared camera 1 according to the present invention, the heat radiation walls 6a and 26 may contact to only the inner wall of the lens barrel but does not contact to the lens holding frame 11. In this way, since the heat radiation walls 6a and 26 are connected to the inner wall of the lens barrels 6 and 7, heat discharge efficiency from the inner wall of the lens barrels 6 and 7 to the outside can be improved, and temperature elevation in the lens barrels 6 and 7 can be further inhibited.

Moreover, in the lens unit for infrared camera 1 according to the present invention, the shielding wall 11a of the lens holding frame 11 is preferably made of plastic resin. In this case, the plastic resin having less thermal conductivity is preferably used for the shielding wall 11a of the lens holding frame 11 to interrupt heat transmission. In this way, in the lens unit for infrared camera 1 according to the present invention, it is made easy to transmit the heat generated in a heat source to a center portion of the lens barrel can be surely prevented together transfer the heat to the side of lens barrels 6 and 7 by forming the shielding wall 11a provided at the closest position to the correction lens 4 using a material having less thermal conductivity.

Also, in the lens unit for infrared camera 1 according to the present invention, the lens barrels 6 and 7 and the heat radiation walls 6a and 26 are preferably made of a metal material having high thermal conductivity selected from an aluminum-base metal material and an iron-base metal material.

In the lens unit for infrared camera 1 according to the present invention, the heat radiation walls 6a and 26 are preferably made of a metal material when thermal conductivity is considered. Moreover, the heat radiation walls 6a and 26 are preferably made of an aluminum-base metal material such as aluminum and aluminum alloy if weight saving and corrosion resistance are considered. Moreover, in a case where the heat radiation walls 6a and 26 are made of an aluminum-base metal material, it is more preferable to provide anodized aluminum treatment on the surfaces to further improve heat discharge property. When anodized aluminum treatment is provided to outer surfaces of the heat radiation walls 6a and 26, micropores are provided on the treated surfaces to enlarge an air-contacting area and discharge factor is raised, whereby an effect to increase heat discharge is further improved. Note also that, from the viewpoint of the strength, sliding property and cost or the like, it is also preferable to select iron-base metal materials such as cast iron, steel, and stainless steel for the heat radiation walls 6a and 26.

Moreover, in the lens unit for infrared camera 1 according to the present invention, the lens barrels 6 and 7 preferably include a heat sink on its outer peripheral surface. Heat discharge efficiency from the outer peripheral surface of the lens barrels 6 and 7 can be further improved by providing a heat sink on the outer peripheral surface of the lens barrels 6 and 7. As a result, the lens unit for infrared camera 1 according to the present invention can further inhibit temperature elevation in the lens barrels 6 and 7. Note that, in addition to providing a heat sink on its outer peripheral surface, the lens barrels 6 and 7 according to the present invention can discharge heat generated therein to the outside thereof more effectively by being made of a metal material having excellent thermal conductivity selected from an aluminum-base metal material and an iron-base metal material.

For reference, a heat sink is a part mounted on machines or electrical components that generate heat for the purpose of lowering the temperature by heat discharge. The property of a heat sink depends on its material, size and shape or the like, and it can be said that the property can be improved when shape of the heat sink is made to have a large surface area. In the lens unit for infrared camera 1 according to the present invention, regarding the conditions related to the heat sink, a preferable condition can be arbitrarily set in consideration of the relationship with other components.

Next, in addition to the embodiment according to the present invention described above, a lens unit for infrared camera 30 as another embodiment having a motor 31 for moving the infrared transmitting lens 5 serving as a zooming lens along the optical axis will be described with reference to the drawings.

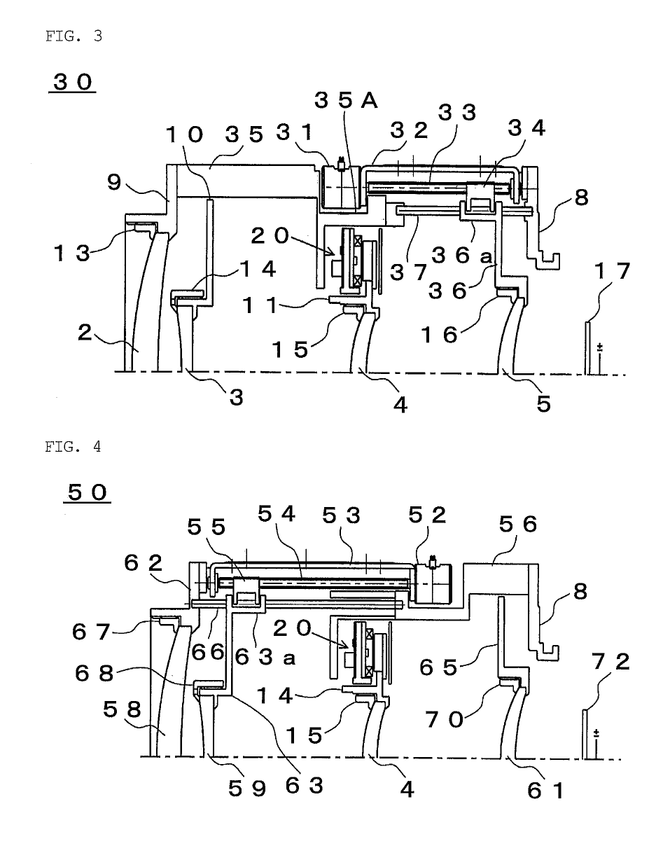

Another embodiment of a lens unit for infrared camera according to the present invention: FIG. 3 is a schematic cross-sectional view illustrating the lens unit for infrared camera 30 of another embodiment according to the present invention. In FIG. 3, components applied the same symbols as those in FIG. 1 provide the same effects, and their detailed explanation is omitted here. As illustrated in FIG. 3, in the lens unit for infrared camera 30 according to the present invention, the infrared transmitting lenses 2 to 5 are housed in a lens barrel 35 via lens holding frames 9 to 11 and 36 holding each of the infrared transmitting lenses 2 to 5. In the lens unit for infrared camera 30, the lens barrel 35 is attachable to and detachable from an infrared camera main body (not shown).

FIG. 3 illustrates that the infrared transmitting lenses 2 to 5 of the lens unit for infrared camera 30 according to the present invention are respectively fixed by the lens pressing rings 13 to 16 of the lens holding frames 9 to 11 and 36. Here, the zooming lens 5 is made slidable along a lead screw 33 and a guide pole 37 driven by the motor 31. So, moving precision of the zooming lens 5 can be improved.

Also, in the lens unit for infrared camera 30 according to the present invention, the lens barrel 35 is preferably provided with a motor housing recess 35A on its outer peripheral surface. By providing the motor housing recess 35A on an outer peripheral surface of the lens barrel 35, the motor 31 can be housed in the motor housing recess 35A, whereby increase in size of the lens unit 30 can be avoided. Moreover, since the motor 31 is provided in the motor housing recess 35A formed on the outer peripheral surface of the lens barrel 35, movement of the zooming lens 5 using the lead screw 33 and the guide pole 37 is easily achieved structurally. Further, the lens unit 30 according to the present invention can inhibit transmission of heat generated in the motor 31 to the inside of the lens barrel effectively by applying such arrangement structure for the motor 31.

Especially, the motor housing recess 35A is preferably provided on the outer peripheral surface of the lens barrel 35 corresponding to a position where the actuator 20 is provided, the actuator 20 performs behavior of image fluctuation correction of the infrared transmitting lens serving as a correction lens using magnetic means to prevent image fluctuation of a photographed image as has been described above in detail. Therefore, the thickness of an outer wall of the lens barrel 35 corresponding to a position where the actuator 20 is provided can be made thinner than that of other portions. Thus, discharged of the heat generated in the actuator 20 can be made more effective. Especially, even the motor 31 is provided in the motor housing recess 35A, the motor 31 mainly generates heat only when the zooming lens 5 travels, and does not generate heat usually. Hence, heat discharge efficiency from the actuator 20 is not adversely affected significantly.

As the lens unit 1 described before, especially in infrared cameras for detecting infrared rays of a mid-infrared region and a far-infrared region such as the lens unit 30 according to the present invention, in a case where a part serving as a heat source is installed in the lens barrel, and influence of infrared rays radiated from the part makes object recognition difficult, i.e. it might be cause of deterioration of the quality of imaging. So, in a so-called mid- or far-infrared camera, it is preferable that a part which may serve as a heat source is not installed in a lens barrel from the viewpoint of the quality of imaging.

Here, when a zooming mechanism is provided as in the lens unit 30 according to the present invention, the motor 31 for driving the zooming lens 5 is necessary structurally, and the amount of heat generation of this motor is large compared with that of other electrical or electronic devices. However, in infrared cameras, providing the motor 31 for driving the lens close to an inner wall of the lens barrel 35 as in a visible light camera may deteriorate the quality of imaging, and is not preferable. Hence, dedicated equipment for cooling a heat source such as a heat pipe can be considered may be additionally used; but such measure may cause a complicated structure or increase of the manufacturing cost.

Then, in the lens unit for infrared camera 30 having a zooming function according to the present invention, the motor housing recess 35A for housing the motor 31 to prevent that the motor 31 substantially protrudes from the outer peripheral surface of the lens barrel 35 is provided on the outer peripheral surface of the lens barrel 35, and the motor 31 is housed therein. Consequently, the driving shaft of the motor 31 can be connected to the other end of the lead screw 33 having one end connected to the lens barrel in a rotatable manner. Moreover, on the side of the lens barrel of the lead screw 33, the guide pole 37 can be provided to the lens barrel 35 to be parallel with the lead screw 33.

In the state, to the lead screw 33 formed with a male screw on an outer periphery, a guide member 34 having an gearing unit for gearing with this male screw is threaded, and the guide member 34 is slidably coupled to the guide pole 37 provided substantially parallel with the lead screw 33. Moreover, the guide member 34 is connected to the lens holding frame 36 by a connecting unit 36a provided in the lens holding frame 36 for the zooming lens 5. Hence, when the driving shaft of the lead screw 33 is made rotate by rotation of the driving shaft of the motor 31, the rotational motion is converted into a linear motion in an axial direction, which makes the lens holding frame 36 holding the zooming lens 5 travel along the optical axis.

In FIG. 3, the lens holding frame 36 for the zooming lens 5 is connected to the lead screw 33 and the guide pole 37 by means of the connecting unit 36a via the guide member 34. However, a method for connecting the lens holding frame 36 to the lead screw 33 and the guide pole 37 is not limited to this manner. For example, an gearing unit for threading into the lead screw 33 and a guide unit for inserting the guide pole 37 are provided on the connecting unit 36a itself of the lens holding frame 36, and by means of the connecting unit 36a, the lens holding frame 36 for the zooming lens 5 may be made slidable in the direction of the optical axis by the lead screw 33 and the guide pole 37.

As described above, when the lens unit for infrared camera 30 having a zoom function according to the present invention s used, because the motor 31 for moving the zooming lens 5 is provided on the outside of the lens barrel 35, image quality of a night vision image is improved. Also, even when the motor 31 for driving the zooming lens is provided on the outside of the lens barrel 35 as in the present invention, the motor 31 is provided not to protrude from the outer periphery of the lens barrel 35, and hence the outer diameter of the lens barrel 35 is not increased. Further, even when the motor 31 is provided outside the lens barrel 35, as described above, the lens holding frame 36 for holding the zooming lens 5 can make the zooming lens 5 travel smoothly along the optical axis by the lead screw 33 and the guide pole 37.

Further, the lens unit for infrared camera 30 having a zoom function according to the present invention is preferably provided with a lid body 32 that covers the lead screw 33 and the guide pole 37 from the outer peripheral side of the lens barrel 35 and makes the lens barrel 35 hermetically sealable.

In the state, since the lid body 32 provides the condition with excellent heat discharge property regarding its material and shape or the like, heat generated in the motor 31 can be efficiently discharged to the outside of the lens barrel 35. Also, by forming the lid body 32 using a material with excellent heat discharge property, even if the electrical or electronic devices which may serve as a heat source are provided in the lens barrel 35, heat generated in the electrical or electronic devices is discharged to the outside of the lens barrel 35 via the lid body 32, and hence deterioration of the quality of imaging due to heat radiation can be inhibited.

By the way, the lens unit for infrared camera 30 according to another embodiment of the present invention illustrated in FIG. 3 includes the actuator 20 having a mechanism to optically correct fluctuation of a photographed image as in the embodiment described above. Even if such actuator 20 which may serve as a heat source is installed in the lens barrel 35, deterioration of the quality of imaging due to heat generated in the actuator 20 can be prevented more effectively by applying the lid body 32 having an excellent heat discharge property.

Note that the lens unit for infrared camera having a zoom function is not limited to an aspect of the lens unit 30 according to the embodiment of the present invention illustrated in FIG. 3. Another embodiment belonging to the present invention will be described below.

FIG. 4 is a schematic cross-sectional view illustrating a lens unit for infrared camera 50 having a zoom function according to still another embodiment of the present invention. Hereinafter, the lens unit 50 according to another embodiment of the present invention will be described with reference to the drawings. The main difference between embodiments illustrated in FIGS. 3 and 4 is that the lens unit for infrared camera 30 having a zoom function of FIG. 3 makes the infrared transmitting lens 5 which is the 4th lens from the object side travel, while the lens unit for infrared camera 50 having a zoom function of FIG. 4 makes the infrared transmitting lens 59 which is the 2nd lens from the object side travel. That is, the lens unit for infrared cameras 30 or 50 according to the present invention can arbitrarily set a zooming lens to other infrared transmitting lenses and an arrangement structure of a motor that makes the zooming lens travel as long as the condition of the present invention is satisfied. Note that, since structures having a difference only in arrangement positions of the motors 31 or 52 are illustrated in FIGS. 3 and 4, a detailed explanation regarding the lens unit for infrared camera having a zoom function according to still another embodiment of the present invention illustrated in FIG. 4 is omitted.

Anyhow in FIG. 4, symbol 50 denotes a lens unit for infrared camera having a zoom function, symbol 52 denotes a motor for driving a lens, symbol 53 denotes a lid body, symbol 54 denotes a lead screw, symbol 55 denotes a guide member, symbol 56 denotes a lens barrel, symbols 58, 59, 4 and 61 denote an infrared transmitting lens, symbols 62, 63, 14 and 65 denote a lens holding frame, symbol 63a denotes a connecting unit, symbols 6 and 7, 68, 15 and 70 denote a lens pressing ring, symbol 20 denotes a mechanism for correcting fluctuation by a hand movement, and symbol 72 denotes an image sensor.

Also, in each of the lens unit for infrared cameras 30 or 50 having a zoom function according to another embodiment, the motors 31 or 52 are preferably a stepping motor.

Here, the stepping motor is a so-called open-loop control motor that basically needs no feedback to perform control of an accurate speed or positioning with a simple circuit configuration. Accordingly, the lens unit for infrared cameras 30 or 50 having a zoom function according to the present invention can perform fine motor control receiving a control signal from an infrared camera main body by employing a stepping motor as the motor for driving the zooming lens. Note that, since a structure and a principle of the stepping motor is well known, description in detail is omitted here.

Hence, the lens unit for infrared cameras 30 or 50 having a zoom function according to the present invention more preferably employs a scheme that the above described stepping motors 31 or 52 are applied as a motor for driving a zooming lens, the lead screws 33 or 54 are connected to the driving shaft of the motors, and the zooming lenses 5 or 59 are driven to slide in the direction of the optical axis by rotation of the lead screws 33 or 54. With such structure, the lens unit for infrared cameras 30 or 50 having a zoom function according to the present invention can further improve precision of movement and silence in driving when the zooming lenses 5 or 59 are traveled.

Also, in the lens unit for infrared cameras 30 or 50 having a zoom function according to the present invention, regarding a material of the lens barrels 35 or 56 and the lid bodies 32 or 53, it is most preferable to use metal materials considering thermal conductivity. Moreover, among these, it is preferable to select and use a metal material having an excellent thermal conductivity selected from an aluminum-base metal material and an iron-base metal material appropriately in accordance with requested property.

That is, regarding a material of the lens barrels 35 or 56 and the lid bodies 32 or 53, it is preferable to use aluminum-base metal materials such as aluminum and aluminum alloy or the like if give priority to weight saving. In a case where an aluminum-base metal material is used, it is preferable to provide anodized aluminum treatment provided with micropores on the surfaces to further improve heat discharge property. Note that, from the viewpoint of the strength, sliding property and cost or the like, it is preferable to select iron-base metal materials such as cast iron, steel, and stainless steel or the like for the material of the lens barrels 35 or 56 and the lid bodies 32 or 53.

Note that, in the lens unit for infrared cameras 30 or 50 having a zoom function according to the present invention, the lid bodies 32 or 53 may be provided with a heat sink on its outer peripheral surface. By providing a heat sink on an outer peripheral surface of the lid body 32, the lens units 30 or 50 according to the present invention can further improve efficiency of heat discharge from the outer peripheral surface of the lens barrels 35 or 56.

The infrared camera according to the present invention: The infrared camera according to the present invention (not shown) is characterized in that it uses the lens unit for infrared cameras 1, 30 or 50 according to the present invention described above. Accordingly, because the lens unit for the infrared camera according to the present invention is used, an infrared camera is excellent in optical property. Also, it is obvious that with increased performance of the electrical and electronic devices as a heat source such as a mechanism for correcting fluctuation by a hand movement, the amount of heat generation tends to increase year by year. Thus, in the future, the infrared camera may have an increased risk of drawbacks associated with heat such as unstable operation and/or reduced processing speed. However, the infrared camera according to the present invention can eliminate occurrence of the problems due to heat generated in the actuator 20 of the mechanism for correcting fluctuation by a hand movement and the motors 31 or 52 for the zooming lens by using the lens unit for infrared cameras 1, 30 or 50 according to the present invention described above. That is, an infrared camera with excellent in optical property can be provided.

As described above, when the lens unit for infrared camera according to the present invention is used, reflection of heat emitted from the mechanism on a photographed image can be prevented in the configuration where a mechanism for optically correcting an image fluctuation is provided in the lens barrel. Hence, an infrared camera provided with the lens unit for infrared camera according to the present invention can accurately perform object recognition in the dark and can be suitably used in vehicle-mounted far-infrared systems and surveillance cameras for security purpose, or the like.

1. A lens unit for infrared camera including:
one or more infrared transmitting lenses;
a lens barrel which houses the infrared transmitting lens via a lens holding frame; and
an actuator for performing image fluctuation correction of an infrared transmitting lens serving as a correction lens using magnetic means to prevent image fluctuation of a photographed image,
wherein the lens holding frame for the infrared transmitting lens serving as the correction lens includes a fixing opening for the infrared transmitting lens and a shielding wall standing in an optical axis direction on an outer periphery of the fixing opening for the lens, and a separating space is provided between the correction lens and the lens barrel.

2. The lens unit for infrared camera according to claim 1, wherein a heat radiation wall is provided on at least one of an object side and an imaging side along the optical axis in the separating space.

3. The lens unit for infrared camera according to claim 1, wherein the heat radiation wall is disposed from a distal end of the shielding wall provided on the lens holding frame for the correction lens toward an inner wall of the lens barrel.

4. The lens unit for infrared camera according to claim 1, wherein the heat radiation wall extends from an inner wall of the lens barrel.

5. The lens unit for infrared camera according to claim 1, wherein the shielding wall of the lens holding frame is made of plastic resin.

6. The lens unit for infrared camera according to claim 1, wherein the lens barrel includes a heat sink on its outer peripheral surface.

7. The lens unit for infrared camera according to claim 1, further including a motor that makes an infrared transmitting lens serving as a zooming lens travel along the optical axis,
wherein the zooming lens is made capable of sliding along a lead screw and a guide pole by being driven by a motor.

8. The lens unit for infrared camera according to claim 7, wherein the lens barrel includes a motor housing recess on its outer peripheral surface.

9. The lens unit for infrared camera according to claim 7,
wherein the lens barrel includes a motor housing recess for housing the motor on its outer peripheral surface to prevent that the motor substantially protrudes from the outer peripheral surface of the lens barrel and houses the motor therein, and is provided with a lid body that covers the lead screw and the guide pole from an outer peripheral side of the lens barrel and makes the lens barrel hermetically sealable.

10. The lens unit for infrared camera according to claim 7, wherein the motor is a stepping motor.

11. The lens unit for infrared camera according to claim 2, wherein the lens barrel and the heat radiation wall are made of a metal material having high thermal conductivity selected from an aluminum-base metal material and an iron-base metal material.

12. An infrared camera comprising the lens unit for infrared camera according to claim 1.
